(19) United States
(12) Patent Application Publication
(10) Pub. No.: US 2022/0407129 A1
(43) Pub. Date: Dec. 22, 2022

(54) DEVICE AND METHOD FOR MONITORING BATTERY SYSTEMS

(71) Applicant: Dragonfly Energy Corp., Reno, NV (US)

(72) Inventor: Denis Phares, Reno, NV (US)

(73) Assignee: Dragonfly Energy Corp., Reno, NV (US)

(21) Appl. No.: 17/312,187

(22) PCT Filed: Dec. 18, 2020
(86) PCT No.: PCT/US2020/065896

§ 371 Date: Jun. 9, 2021

Related U.S. Application Data
(60) Provisional application No. 62/951,181, filed on Dec. 20, 2019.

(51) Int. Cl. H01M 10/48; H01M 10/42; H01M 50/269

(52) U.S. Cl. CPC H01M 10/482; H01M 10/4257; H01M 50/269; H01M 2010/4278

(57) ABSTRACT

Embodiments of a device and methods to operating the same are described that can provide high level status information about a battery having multiple modular battery packs which may be arranged in different numbers and/or electrical configurations depending on the specific application. In some embodiments, a smart hub is in communication with battery packs within the battery and configured to selectively query low level status information associated with individual battery packs based on a stored pack configuration that can be updated by a user. The device allows more efficient provision of battery information during flexible assembly and connection of the battery packs.

### RELATED APPLICATIONS

This application claims the benefit of priority under 35 U.S.C. § 119(e) to U.S. Provisional Application Ser. No. 62/951,181, filed Dec. 20, 2019, the disclosure of which is incorporated herein by reference in its entirety.

### FIELD

Disclosed embodiments are related to devices and methods for monitoring battery systems.

### BACKGROUND

A battery may include multiple battery packs physically secured in an enclosure, and electrically connected in a range of electrical configurations. For example, multiple battery packs may be connected in parallel to provide a higher current, or in series to increase output voltage. Further, many battery packs and systems may be provided to customers as modular components that may be assembled together in any number of different configurations with battery packs and/or cells located in series and/or parallel with one another depending on the desired application and overall battery configuration.

### SUMMARY

Embodiments of a device and methods to operating the same are described that can provide high level status information about a battery having multiple battery packs. In some embodiments, a smart hub is in communication with battery packs within the battery and configured to selectively query low level status information associated with individual battery packs based on a stored pack configuration that can be updated by a user. The device allows more efficient provision of battery information during flexible reconfiguration of battery packs.

According to some embodiments, a device for providing a user information regarding a battery is provided. The battery includes a plurality of battery packs. The device comprises a hub configured to be in communication with each one of the plurality of battery packs to receive first status information associated with each one of the plurality of battery packs. The hub comprises at least one non-volatile memory configured to store a pack configuration of the battery; at least one processor configured to update the pack configuration based on an input from the user; identify an electrical connection configuration based on the configuration; based on the identified electrical connection configuration, selectively query a status of the received first status information; and determine second status information associated with the battery based on the selectively queried status and the electrical connection configuration.

According to some embodiments, a method for providing a user information regarding a battery including one or more battery packs is provided. The method comprises receiving, with a hub, first status information associated with each respective battery pack of the plurality of battery packs; receiving an input from the user; based on the received input, updating a pack configuration stored in a non-volatile memory of the hub; identifying an electrical connection configuration based on the pack configuration; based on the identified electrical connection configuration, selectively querying a status of the received first status information; and determining second status information associated with the battery based on the selectively queried status and the electrical connection configuration.

According to some embodiments, a system for providing a user information regarding a battery is provided. The battery includes one or more battery packs. The system comprises at least one computer-readable storage device having stored thereon executable instructions; and at least one processor programmed by the executable instructions to perform a method. The method comprises acts of receiving, with a hub, first status information associated with each respective battery pack of the plurality of battery packs; receiving an input from the user; based on the received input, updating a pack configuration stored in a non-volatile memory of the hub; identifying an electrical connection configuration based on the pack configuration; based on the identified electrical connection configuration, selectively querying a status of the received first status information; and determining second status information associated with the battery based on the selectively queried status and the electrical connection configuration.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is an illustrative diagram of components of an exemplary device for providing battery information to a user, according to some embodiments;

FIG. 1B is an illustrative block diagram of components of an exemplary implementation of a hub, according to some embodiments;

FIG. 2 is a flow diagram of an exemplary method for providing information regarding a battery to a user using a device as shown in FIG. 1, according to some embodiments;

FIG. 3 is a flow diagram of a method that can be an exemplary implementation of the selectively querying act as shown in FIG. 2, according to some embodiments.

### DETAILED DESCRIPTION

Some batteries may include removable battery packs or are otherwise reconfigurable to suit the needs of a particular application. Further, some battery monitoring systems can collect and provide information about modular battery packs within a battery. However, unlike dedicated monitoring systems for static battery configurations, such information for modular battery systems is limited to operating status and conditions of individual battery pack such as pack capacity, state of charge, individual voltage, individual current. etc. The inventors have recognized several deficiencies in such prior systems. For example, when the number of packs become large, individual pack data monitoring can provide a large amount of data that can be overwhelming to a user, yet fail to provide useful information about the overall battery status based on the inter-pack configuration within the battery. Moreover, an electrical configuration of modular packs can change between different applications. For example, different arrangements and numbers of modular battery packs that are in parallel and/or in series with one another may be used depending on the particular application to provide different voltages and/or currents. However, unlike dedicated monitoring systems designed for a single battery configuration, typical monitoring systems for modular battery packs only offer individual monitoring of the different packs' operating parameters which may be insufficient for certain applications. For example, individual monitoring puts the burden on a user to identify various overall operating parameters of the battery system such as capacity and/or current imbalances between packs located in parallel, voltage imbalances between serially connected packs, and/or other appropriate battery level operating information. Accordingly, the inventors have recognized there is a need to provide useful battery information that can adjust flexibly depending on the pack configuration to a user.

In view of the above, the Inventor has recognized the benefits associated with determining high level status information about an overall battery system even when modular battery packs which may be arranged in any number of configurations. Accordingly, aspects of the present application may provide a device and a method for using the same to provide a user information regarding a battery having multiple battery packs that contain high level status information that can reflect the particular battery configuration, which is highly flexible and customizable. In some embodiments, a user may input a configuration of the packs, or update the configuration of the packs to reflect a change in configuration, and the device may identify the battery configuration, collect statuses of battery packs and cells within the battery, and aggregate such statuses to determine the high level status information based on the battery configuration, such that the information may be used to update the current operating status of the battery and/or it may be provided to a user. For example, the high level status information may be used to update parameters stored in a the memory of a system for future output and/or recall, display information on an appropriate display for a user, output an alarm to a user based on the high level status information if appropriate, and/or any other appropriate use.

Moreover, devices according to aspects of the present application may selectively and automatically screen multiple status information based on the pack configuration to determine a high level status information for providing to the user. The high level status information may indicate operating status and/or fault status of not an individual battery pack, but a group of battery packs connected in a certain way within the battery. High level status information may include, for example, operating voltages and/or currents of the overall battery and/or individual blocks including multiple battery packs located in parallel, battery capacity, battery state of charge, charge balance between parallel components (e.g. battery packs and blocks of battery packs located in a parallel electrical configuration), current imbalances between parallel components, voltage differentials between components located in series (e.g. battery packs and blocks of battery packs located in series), and/or any other appropriate high level status information related to the battery's operation that is not readily apparent from the individual low level information available from the individual battery packs.

It should be understood that any appropriate low level information associated with an individual battery packs may be used with the systems and methods disclosed herein. Examples of such low-level information that may be monitored from the individual battery packs using any appropriate type of sensor may include, but is not limited to, a voltage, a current, a block imbalance, a temperature, a high temperature condition (e.g. temperature above a threshold temperature as measured by a temperature sensor), a Coulomb count, and/or any other appropriate status information regarding an individual battery pack, which depending on the embodiment may include one or a plurality of cells. Appropriate types of sensors that may be included in the battery pack to provide the desired low level information may include, but are not limited to, coulomb counters, voltage sensors, current sensors, temperature sensors, state of health monitors, and/or any other appropriate type of sensor.

In some embodiments, a hub is provided in the device that provides communication with battery packs within a battery. The hub may be considered a “smart hub,” and may, in some examples communicate with each battery pack wirelessly using any suitable wireless communication protocol to avoid cable clutter and increase the flexibility to reconfigure the packs in a battery without changing wiring for communication. The wireless communication protocol may be bluetooth, Zigbee, 802.11 Wi-Fi, Sub-1 GHz radio frequency (RF) connectivity, RFID (Radio-Frequency Identification). NFC (Near-Field Communication), cellular network, or other appropriate wireless communication protocol. A battery may provide energy storage for a consumer or industrial user to power a household as off-grid storage, vehicles such as a car, a recreational vehicle (RV) or a boat, consumer electronics, industrial machinery etc. Battery packs within the battery are modules that can be implemented in any suitable form and from any battery provider, and can be flexibly rearranged into different electrical configurations such as series/parallel and into different physical configurations such as stacking or arrangement in different positions and/or orientations.

In an exemplary use scenario, a user may input to the hub an electrical and/or physical configuration of the battery packs, for example using a user interface (UI) either in the device itself, or on an external electronic device such as but not limited to a smart phone. a portable computer, a tablet computer, smart watch or other wearable device, a bluetooth paired keyboard, touchpad or mouse, and any other suitable interface. The input may be an initial configuration, or an update when the configuration is altered. The hub takes the user input, updates a stored pack configuration, and identifies the electrical connection configuration of how the packs are electrically connected between each other. While the hub is in communication with each pack to receive the pack's status information, the hub can select one or more relevant status information to query based on the electrical configuration of the various battery packs relative to each other. The hub can then provide a high level indication of the battery health and/or operating status that is customized according to the particular inter-pack electrical configuration prior to updating the operating parameters of the battery and/or presenting to the user. Therefore aspects of the present application may provide a flexible and user defined way to work with a modular battery. However, embodiments of the present application may be used or incorporated into any number of different battery systems as well including static battery systems.

Turning to the figures, specific non-limiting embodiments are described in further detail. It should be understood that the various systems, components. features, and methods described relative to these embodiments may be used either individually and/or in any desired combination as the disclosure is not limited to only the specific embodiments described herein.

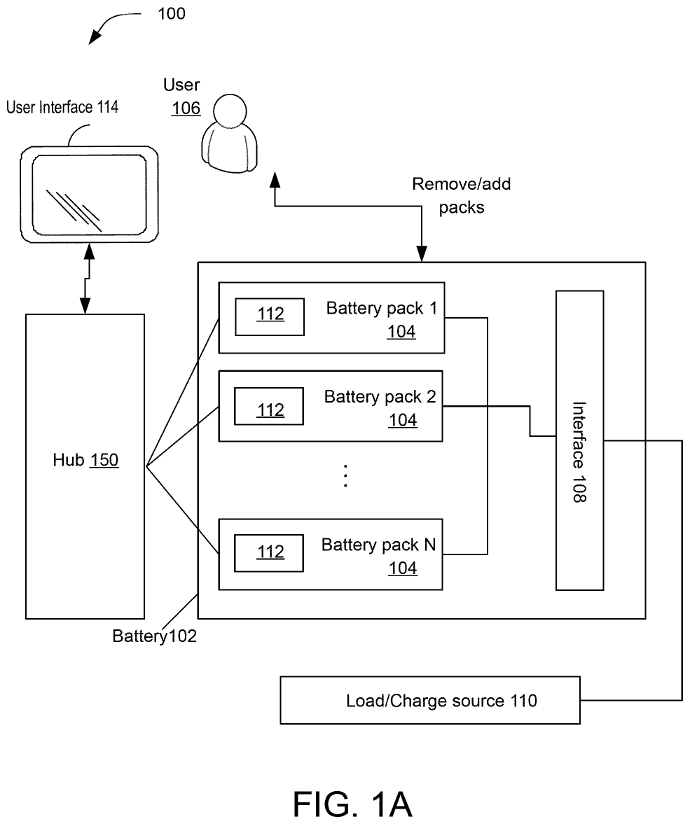

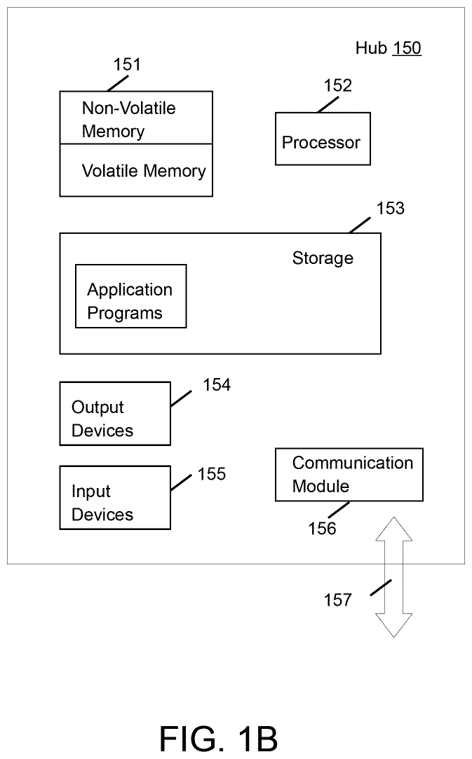

FIG. 1A is an illustrative diagram of components of an exemplary device 100 for providing battery information to a user 106. according to some embodiments. FIG. 1A shows a battery 102 having multiple battery packs 104. Battery 102 may have a physical design that includes an enclosure where each battery pack 104 can be inserted or removed from the enclosure by user 106. However, instances in which the battery packs are simply connected to one another in a desired electrical configuration in a flexible manner without the use of an enclosure are also contemplated. Further, given the modular nature of the battery packs, the battery packs may be arranged in any appropriate manner relative to one another and in any appropriate number for a desired application.

Battery 102 may also have one or more electrical interfaces 108 that electrically interconnects the battery packs 104 when they are installed within battery 102, and to provide an electrical output for the battery to an external load/charge source 110 to supply power/be recharged. Any suitable electrical connector types and wiring may be used within interface 108. In particular, interface 108 may comprise terminals that can be used to connect the multiple battery packs in a desired electrical and/or physical configuration. For example, the battery packs may be interconnected to one another in any appropriate combination of series and/or parallel electrical connections using any appropriate electrical connection including, but not limited to, solid-state or relay switches, physical wired connections or any other appropriate interface 108. Depending on the particular application, the battery packs may be arranged in different physical and/or electrical configurations. For example, a battery to power a household and a battery to power a boat may have different average and peak powers, nominal voltages, average and peak currents, capacities. and/or other operating considerations. Thus, batteries used for these applications may include different numbers and/or configurations of battery packs to meet the desired operating parameters. Additionally, in some instances, a user 106 may also want to physically remove or replace a pack 104 having electrochemical cells that have deteriorated, or install additional packs 104. Additionally, interface 108 allows a pack 104 to be configured to connect in series or in parallel with a select number of other packs.

Each battery pack 104 within a battery 102 may be of substantially the same design. However, packs of different physical and/or electrical specification may be mixed and matched to suit a customer's needs. In one non-limiting example, the battery 102 may be a 48 V battery system that includes a number of battery packs of 48 V. 24 V and/or 12 V nominal output voltage. The battery packs may be electrically connected to provide a desired 48 V output voltage by for example putting several lower output voltage packs in series, and a desired peak output current by for example putting several packs in parallel.

Battery pack 104 may be a rechargeable battery pack and may have any suitable circuitry and one or more electrochemical cells (not shown). The electrochemical cells may have lithium-based chemistry and may be a lithium-ion battery cell or lithium-polymer battery cell, although aspects of the present application are not limited to lithium-based battery cells and any suitable electrochemistry and related electrode and electrolyte materials for rechargeable energy storage may be used. Circuitry within a pack can provide current and voltage regulation during the recharge/discharge process for cells within the pack. The circuitry may also provide monitoring of status information of the pack and digitization of the status information as digital data for reporting outside of the pack, for example with a communication module 112.

The status information monitored within a battery pack may be a first type of status information that is considered lower level, and may comprise a plurality of detailed characteristics of the battery pack and the electrochemical cells within the individual pack. Exemplary types of such first type of status information being monitored for individual battery packs include but are not limited to: a voltage, a current, a block imbalance. a temperature, a thermal runaway condition (e.g. temperature above a threshold temperature as measured by a temperature sensor), a Coulomb count, and/or any other appropriate status information regarding the battery pack.

In FIG. 1A. the device 100 also includes a hub 150 that communicates with each individual battery pack 104 of battery 102 to send and receive data and control signals. In particular, hub 150 may form a communication link with the battery packs 104 to receive the status information associated with each pack 104. As the packs within battery 102 are reconfigurable, hub 150 may also obtain a pack configuration about how the packs are organized within battery 102. The pack configuration may specify a quantity of battery packs and a battery pack topography within battery 102. A battery pack topography indicates electrical configurations between the packs, such as how the battery packs are connected to each other and which battery packs are in parallel and which ones are in series. The pack configuration may also specify physical configurations within battery 102 such as a physical location, a physical orientation, an electrical connection type, and an identifier for each battery pack 104. For example, the pack configuration may indicate that the battery is a 48 V battery that includes three 12 V battery packs connected in series, among other components. As another example, the pack configuration may indicate that battery pack #1 is located in the battery enclosure at a first slot location among a plurality of battery pack slots. In yet another example, the pack configuration may indicate that pack #1 and #2 are connected in series, while pack #3 and #4 are connected in parallel. This may also include indicating a first group of battery packs are in parallel with one and are in series with one or more other groups of battery packs. Of course, it should be appreciated that depending on how the packs are arranged and interconnected inside the battery 104 to suit a particular application, other information may be included in a pack configuration.

FIG. 1B is an illustrative block diagram of components of an exemplary implementation of a hub 150, according to some embodiments. In FIG. 1B. hub 150 includes one or more processors 152 and a non-transitory computer-readable storage medium 151 that may include, for example, volatile and/or non-volatile memory. The memory 151 may store one or more instructions to program the one or more processors 152 to perform any of the methods described herein. Hub 150 may also store a pack configuration about the battery 102 within memory 151, for example within the non-volatile memory. Hub 150 may also include other types of non-transitory computer-readable medium, such as storage 153 (e.g., one or more disk or solid state drives) in addition to the system memory 151. The storage 153 may also store one or more application programs and/or resources used by application programs (e.g., software libraries), which may be loaded into the memory 151. In some embodiments, a list of alternative pack configurations may be generated and stored in the memory 151 and/or storage 153. and hub 150 may output a selectable list of possible pack configurations to the user 106 to facilitate the user to input the current pack configuration.

Still referring to FIG. 1B, hub 150 may have one or more input devices and/or output devices, such as devices 154 and 155. These devices can be used, among other things, to present a user interface such as user interface 114 as shown in FIG. 1. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 155 may include a microphone for capturing audio signals, and the output devices 154 may include a display screen for visually rendering, and/or a speaker for audibly rendering, recognized text.

In some embodiments, a pack configuration representing a defined battery pack layout may be updated based on a user input using input devices 155. For example, a user may manually provide or select from a list the correct pack configuration when changing out a battery pack or initially defining a configuration for a battery. In some embodiments, the input may be collected on an user interface such as user interface 114 that provides interactive feedback that includes one or more of visual, audio, tactile responses to the user input as verification to reduce user input error. While FIG. 1B shows input and output devices as part of hub 150, it should be appreciated that it is not a requirement that the hub 150 or device 100 has a physical user interface for providing input or output. For example, the device 100 may communicate with a user's existing electronic device such as a smartphone for displaying information and gathering user input.

In some embodiments. a pack configuration update needs not be initiated by a user input. For example, when a change in synced battery pack is detected from removing or addition of a battery pack, the hub may cause the device to prompt the user for a new pack configuration. In some embodiments, the device may determine two or more possible alternative pack configurations to present to the user for selection, which can reduce operator error and improve operation efficiency as the user does not have to manually enter a large number of pack configuration parameters.

As shown in FIG. 1B, hub 150 may also comprise a communication module 156 to enable communication via communication link 157 to the communication modules 112 of the battery packs 104. Examples of protocols for the communication link include wired connections such as CANBUS (Controller Area Network), and wireless connections such as Bluetooth, Zigbee, 802.11 Wi-Fi, Sub-1 GHz radio frequency (RF) connectivity, RFID (Radio-Frequency Identification), NFC (Near-Field Communication) and cellular network. In one non-limiting example, each communication module 112 on the battery pack 104 comprises components for bluetooth communication with the hub 150. In some embodiments, each of the battery packs may individually synchronize or pair with the hub 150 during a startup of the device 100, or when a pack is added, removed or otherwise a change in pack configuration is made in battery 102. A synchronization may include establishing a wireless connection between the hub and a battery pack, as well as receiving an initial batch of status information about the battery pack at the hub.

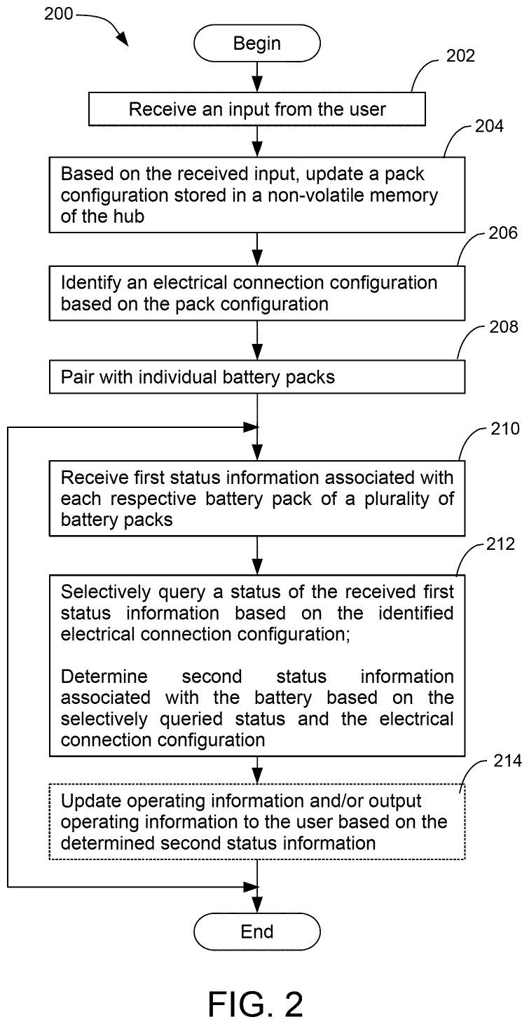

FIG. 2 is a flow diagram of an exemplary method 200 for providing information regarding a battery to a user using a device as shown in FIG. 1, according to some embodiments. Method 200 begins with identification of a pack configuration of the battery. At act 202, the device receives an input from the user, for example using input devices 155 in hub 150. At act 204, the device updates a pack configuration stored in non-volatile memory 151 of hub 150 based on the received user input. An example will be described herein with reference to two battery packs, a first and a second pack within a battery 102. In this example, the user may input a pack configuration that indicates the first and second battery pack are connected in series/parallel with each other. However, it should be understood that this process may be implemented with any number of battery packs in any number of different configurations including combinations of battery packs located in series and/or parallel with one another as the disclosure is not limited in this fashion. At act 206, the processor within hub 150 identifies the series/parallel electrical connection between the first and second battery pack based on the stored and updated pack configuration.

At act 208, hub 150 performs a pairing process with individual battery packs. Pairing may include synchronization between the hub and a battery pack to establish a communication link, and transmission of commands and data in between the hub and the battery pack. In some embodiments, pairing may be initiated by the hub 150. which pings individual battery packs using identification information such as a serial number, a bluetooth ID etc. that is obtained from the pack configuration. Pairing may be initiated manually by a user after prompting the user. For example, a user may input the identifying information and locations of each battery pack, initiate a pairing of a particular battery pack when prompted to identify a battery pack associated with an indicated position within the electrical configuration stored in memory, and/or any other appropriate manual process. Additionally, pairing may also be performed automatically as the disclosure is not limited to only manually implemented processes.

At act 210, hub 150 receives a stream of low level status information from each of the battery packs synced with the hub 150. The received low level status information may be stored in a suitable format within the memory 151 of the hub 150. The low level status information may then be processed by the device 100 to synthesize high level status information for provision to the user. Because the hub knows that the first and second packs are electrically connected and that the failure modes for serially or parallelly connected components may differ, at act 212, the hub 150 queries the voltage and current information for the first and second packs from the received stream of low level status information. The query results are then used to determine a high level status information, such as the potential failure in the battery 102 caused by the first and second packs. Hub 150 makes the determination based on the electrical connection configuration (series or parallel) it identified at act 206, as well as the selectively queried voltage and/or current at act 212. It should be appreciated that while FIG. 2 illustrates a process that the selective query is made based on received stream of status information from each battery pack, such a process is by way of illustration only and aspects of the present application may also be implemented by using the hub to directly query the first and second battery packs for the selected information, without the need to first receive information from all packs.

Still referring to FIG. 2, at act 212, the hub 150 determines a high level status information for the battery 102 based on the selectively queried status and the electrical connection configuration. For example, a high level status may include information such as operating voltages and/or currents of the overall battery and/or individual blocks including multiple battery packs located in parallel, battery capacity, battery state of charge, charge balance between parallel components (e.g. battery packs and blocks of battery packs located in a parallel electrical configuration), current imbalances between parallel components, voltage differentials between components located in series (e.g. battery packs and blocks of battery packs located in series), and/or any other appropriate high level status information related to the battery's operation that is not readily apparent from the individual low level information available from the individual battery packs.

The determined high level status information may be used in a variety of ways depending on the specific application. For example, in some embodiment at 214, operating information, such as one or more operating parameters, about the battery stored in a memory of a hub may be updated with the determined high level status information either continuously during operation and/or periodically. Alternatively or additionally, the high level information may be used to output information to a user at 214. In one such embodiment, the high level information itself may be output to a display or other appropriate output device. However, in some embodiments, the hub may output simplified information to a user. For instance, to avoid outputting information which may clutter the output UI for a user, in some embodiments at act 214, the hub 150 may either output a system normal message when the determined high level status information is within normal operating ranges and an alarm, such as a visual alarm, when one or more portions of the high level status information is outside a normal operating range for the battery. This monitoring of low level status information from individual battery packs, determination of high level status information for the battery, updating of operating parameters, and/or outputting information to a user may be done either continuously or periodically as indicated in FIG. 2.

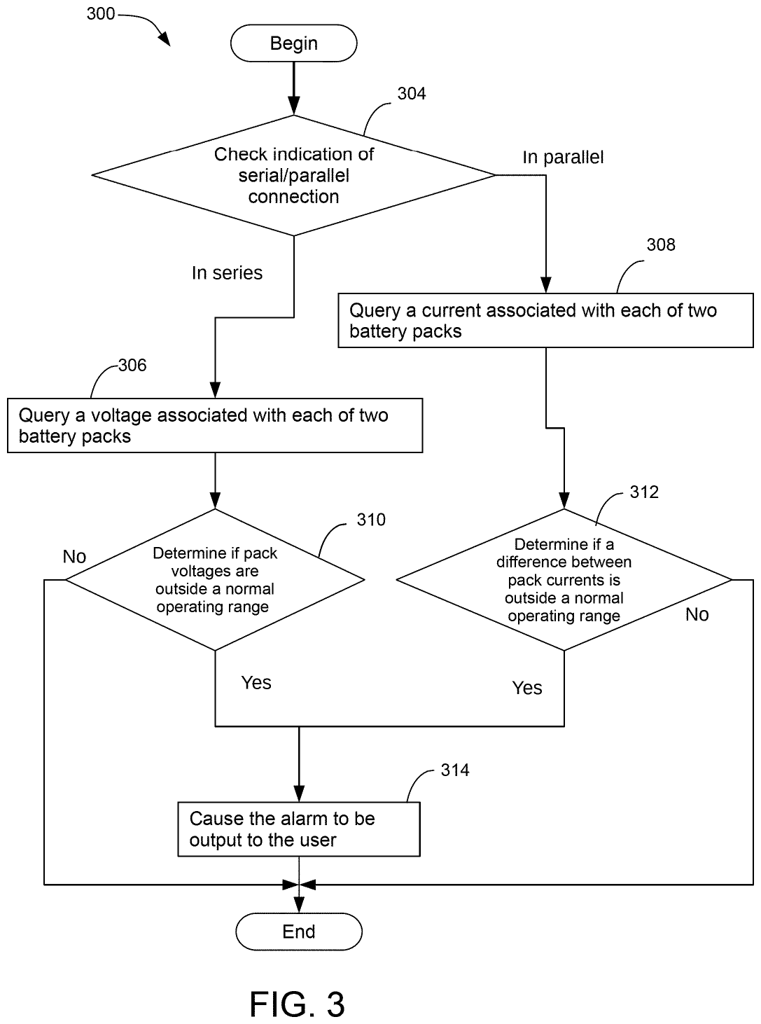

FIG. 3 is a flow diagram of one embodiment of a method 300 that can be implemented for monitoring one or more operating parameters of a battery and outputting an alarm when the monitored parameters are outside of a normal operating range. The inventors have recognized that the hub may be used to compile the received low level pack status information and determine corresponding high level status information as described above relative to FIG. 2. Using this information, it may be possible to flag a potential battery fault or other operating parameter outside of a nominal operating range to a user. For example, when an open circuit voltage of any one of a group of serially connected packs, either above a maximum threshold voltage or below a minimum voltage threshold, may indicate an alarm condition. Alternatively, an imbalanced current being drawn from battery packs that is greater than a threshold current imbalance may also be indicative of an alarm condition. Accordingly, at act 304, the hub 150 checks the electrical connection configuration identified at act 206 in FIG. 2 to see whether the first and second battery pack are connected in series or in parallel. If in series, then method 300 proceeds to act 306 to selectively query a voltage of the first pack and a voltage of the second pack to measure the open circuit voltages of the battery packs. For example if a magnitude of a pack voltage of either battery pack is determined to be outside a desired operating range at 310, it may indicate various undesired conditions associated with the associated battery pack. Alternatively, if the battery packs are located in parallel, in some embodiments, a current of the battery packs is queried at 308. If a difference between the measured currents is outside of a desired operating range, which in this case may be a difference greater than a threshold current imbalance, an alarm condition may again be determined. In either case, once an alarm condition has been identified, at act 314, an alarm may be provided to the user as an indication of a fault in the battery 102. The alarm may also provide the identification and position of the battery pack that is suspected of having an open voltage condition.

While the above described embodiment details the monitoring and outputting of an alarm associated with two potential alarm conditions (i.e. voltage and current imbalances), it should be understood that the methods described herein related to the monitoring and output of information related to high level status information of a flexible modular battery system, including alarms, is not limited to only these parameters. Specifically, the high level information may be used to determine any number of different operating parameters of a battery as detailed previously, and alarm conditions associated with any of these conditions may, or may not, be implemented in a particular system depending on the particular embodiment. Additionally, the monitored information may include monitoring and use of absolute or relative levels. amplitudes. absolute or relative time rates of change of parameters, and/or any other appropriate metric. Additionally, depending on the particular parameter, a normal operating range may include a minimum threshold, a maximum threshold, a range between a minimum threshold in a maximum threshold such that when the parameter is outside the normal operating range for that parameter. an alarm state may be indicated.

Various aspects and functions described herein may be implemented as specialized hardware or software components executing in one or more specialized computer systems. There are many examples of computer systems that are currently in use that could be specially programmed or specially configured. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers. routers, and switches). Examples of particular models of mobile computing devices include iPhones, iPads, and iPod touches running iOS operating system available from Apple, Android devices like Samsung Galaxy Series. LG Nexus, and Motorola Droid X. Blackberry devices available from Blackberry Limited, and Windows Phone devices. Further, aspects may be located on a single computer system or may be distributed among a plurality of computer systems connected to one or more communications networks.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA). a smart phone or any other suitable portable or fixed electronic device.

Depending on the nature of the computing device, one or more additional elements may be present. For example, a smart phone or other portable electronic device may include a camera, capable of capturing still or video images. In some embodiments, a computing device may include sensors such as a global positioning system (GPS) to sense location and inertial sensors such as a compass, an inclinometer and/o ran accelerometer. The operating system may include utilities to control these devices to capture data from them and make it available to applications executing on the computing device.

As another example, in some embodiments, a computing device may include a network interface to implement a personal area network. Such an interface may operate in accordance with any suitable technology, including a Bluetooth, Zigbee or an 802.11 ad hoc mode, for example.

Such a computer device may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format. In the embodiment illustrated, the input/output devices are illustrated as physically separate from the computing device. In some embodiments, however, the input and/or output devices may be physically integrated into the same unit as the processor or other elements of the computing device. For example, a keyboard might be implemented as a soft keyboard on a touch screen. Alternatively, the input/output devices may be entirely disconnected from the computing device, and functionally integrated through a wireless connection.

The computer may be a computer system including an operating system that manages at least a portion of the hardware elements. In some examples, a processor or controller executes an operating system. Examples of a particular operating system that may be executed include a Windows-based operating system, such as. Windows 10, Windows 8, Windows NT, Windows 2000 (Windows ME). Windows XP, Windows Vista or Windows 7 operating systems, available from the Microsoft Corporation. a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly. aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

The terms “code”, “program” or “software” are used herein in a generic sense to refer to any type of computer code or set of computer-executable instructions that can be employed to program a computer or other processor to implement various aspects of the present invention as discussed above. Additionally. it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects. components, data structures, etc. that perform particular tasks or implement particular abstract data types. Typically the functionality of the program modules may be combined or distributed as desired in various embodiments. The instructions may be persistently stored as encoded signals, and the instructions may cause the processor to perform any of the functions described herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements. The media may, for example, be optical disk, magnetic disk or flash memory, among others. In operation, the processor manipulates the data within the memory, and then copies the data to the storage medium associated with the data storage element after processing is completed. A variety of components may manage data movement between the storage medium and other memory elements and examples are not limited to particular data management components. Further, examples are not limited to a particular memory system or data storage system.

Based on the foregoing disclosure, it should be apparent to one of ordinary skill in the art that the embodiments disclosed herein are not limited to a particular computer system platform, processor, operating system. network, or communication protocol. Also, it should be apparent that the embodiments disclosed herein are not limited to a specific architecture or programming language.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an.” as used herein in the specification and in the claims, unless clearly indicated to the contrary, should be understood to mean “at least one.”

The phrase “and/or.” as used herein in the specification and in the claims, should be understood to mean “either or both” of the elements so conjoined. i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently. “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B. with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence. or order of one claim element over another or the temporal order in which acts of a method are performed. but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having.” “containing,” “involving,” and variations thereof herein, is meant to encompass the items listed thereafter and equivalents thereof as well as additional items.

What is claimed is:

1. A device for providing a user information regarding a battery including a plurality of battery packs, the device comprising:
a hub configured to be in communication with each one of the plurality of battery packs to receive first status information associated with each one of the plurality of battery packs, the hub comprising:
at least one non-volatile memory configured to store a pack configuration of the battery;
at least one processor configured to:
update the pack configuration based on an input from the user;
identify an electrical connection configuration based on the configuration;
based on the identified electrical connection configuration, selectively query a status of the received first status information; and
determine second status information associated with the battery based on the selectively queried status and the electrical connection configuration.

2. The device of claim 1, further comprising a communication module is configured to be in wireless communication with each one of the plurality of battery packs.

3. The system of claim 1, wherein
the pack configuration comprises a quantity of battery packs, an electrical connection type for each battery pack, and an identifier for each battery pack.

4. The device of claim 1, wherein
the second status information comprises one or more items selected from the list of: a block imbalance between battery packs connected in parallel, a voltage of battery packs connected in series, a current difference between parallel battery packs.

5. The device of claim 1, wherein the at least one processor is further configured to:
cause the determined second status information to be displayed to the user.

6. The device of claim 1, wherein the at least one processor is further configured to:
cause an alarm to be output to the user based on the determined second status information.

7. The device of claim 6, wherein the electrical connection configuration comprises an indication whether two battery packs of the plurality of battery packs are connected in series or in parallel, and wherein the at least one processor is configured to:
query a voltage associated with each of the two battery packs;
determine if a voltage of either of the two battery packs is outside a normal operating range based on the indication that the two battery packs are connected in series; and
in response to determining that the voltage of either battery pack is outside the normal operating range, cause an alarm to be output to the user.

8. The device of claim 6, wherein the electrical connection configuration comprises an indication whether two battery packs of the plurality of battery packs are connected in series or in parallel, and wherein the at least one processor is configured to:
query a current associated with each of the two battery packs;
determine if a difference between the currents of the two battery packs is greater than a threshold based on the indication that the two battery packs are connected in parallel; and
in response to determining that the difference between the currents is greater than the threshold, cause an alarm to be output to the user.

9. The device of claim 1, wherein the at least one processor is further configured to manage one or more user interfaces, the one or more user interfaces configured to:
present to the user a selection of two or more possible configurations, and
receive an input from the user indicating that one of the two or more possible configurations is selected.

10. A method for providing a user information regarding a battery including one or more battery packs, the method comprising:
receiving, with a hub, first status information associated with each respective battery pack of the plurality of battery packs;
receiving an input from the user;
based on the received input, updating a pack configuration stored in a non-volatile memory of the hub;
identifying an electrical connection configuration based on the pack configuration;
based on the identified electrical connection configuration, selectively querying a status of the received first status information; and
determining second status information associated with the battery based on the selectively queried status and the electrical connection configuration.

11. The method of claim 10, wherein
the pack configuration comprises a quantity of battery packs, an electrical connection type for each battery pack, and an identifier for each battery pack.

12. The method of claim 11, wherein
the second status information comprises one or more items selected from the list of: a block imbalance between battery packs connected in parallel, a voltage of battery packs connected in series, a current difference between parallel battery packs.

13. The method of claim 10, further comprising:
causing the determined second status information to be displayed to the user.

14. The method of claim 10, further comprising:
causing an alarm to be output to the user based on the determined second status information.

15. The method of claim 14, wherein the electrical connection configuration comprises an indication whether two battery packs of the plurality of battery packs are connected in series or in parallel, and wherein the method further comprises:
querying a voltage associated with each of the two battery packs;
determining if a voltage of either of the two battery packs is outside a normal operating range based on the indication that the two battery packs are connected in series; and
in response to determining that the voltage of either battery pack is outside the normal operating range, causing an alarm to be output to the user.

16. The method of claim 14, wherein the electrical connection configuration comprises an indication whether two battery packs of the plurality of battery packs are connected in series or in parallel, and wherein the method further comprises:
querying a current associated with each of the two battery packs;
determining if a difference between the currents of the two battery packs is greater than a threshold based on the indication that the two battery packs are connected in parallel; and
in response to determining that the difference between the currents is greater than the threshold, causing an alarm to be output to the user.

17. A system for providing a user information regarding a battery including one or more battery packs, the system comprising:
at least one computer-readable storage device having stored thereon executable instructions; and
at least one processor programmed by the executable instructions to perform a method comprising acts of:
receiving, with a hub, first status information associated with each respective battery pack of the plurality of battery packs;
receiving an input from the user;
based on the received input, updating a pack configuration stored in a non-volatile memory of the hub;
identifying an electrical connection configuration based on the pack configuration;
based on the identified electrical connection configuration, selectively querying a status of the received first status information; and
determining second status information associated with the battery based on the selectively queried status and the electrical connection configuration.

18. The system of claim 17, wherein
the pack configuration comprises a quantity of battery packs, an electrical connection type for each battery pack, and an identifier for each battery pack.

19. The system of claim 17, wherein the method further comprises the act of:
causing the determined second status information to be displayed to the user.

20. The system of claim 17, wherein the method further comprises the act of:
causing an alarm to be output to the user based on the determined second status information.
